(19) United States
(12) Patent Application Publication
(10) Pub. No.: US 2011/0050543 A1
(43) Pub. Date: Mar. 3, 2011

(54) MOBILE DEVICE WITH MULTIPLE DISPLAY SCREENS

(76) Inventor: MING-FAR CHIEN, Taipei County (TW)

(21) Appl. No.: 12/546,686

(22) Filed: Aug. 25, 2009

(51) Int. Cl. G09G 5/00; G06F 3/041

(52) U.S. Cl. 345/1.3; 345/173

(57) ABSTRACT

The present invention provides a mobile device with multiple display screens, which incorporates three display screens onto a common laptop with a single display screen; the mobile device at least includes: a first display screen, which is assembled at inner side of an upper cover; and one side adjacent to the second display screen is linked to the base; a second display screen, which is placed on the base; one side is abutted against the first display screen, and the other side abutted against the third display screen; the second display screen can also shift directionally in parallel with the base; and a third display screen, which is placed at inner side of the keyboard; the other side adjacent to the second display screen is linked to the base. The first display screen can be rotatably covered in tune with the second display screen, whilst the third display screen can be rotatably covered in tune with the second display screen. Hence, three display screens can be incorporated onto a mobile device, e.g. laptop, thereby improving its operational flexibility.

### BACKGROUND OF THE INVENTION

The present invention relates generally to a mobile device, and more particularly to an innovative one which incorporates three display screens onto a laptop for improving significantly its flexibility of operation.

The requirements and standards of the human beings are becoming higher with continuous improvement of science and technology. As regards the market of the mobile devices, it is clearly understood that the consumers' demanding requirements are mainly concentrated on those portable and easy-to-operate devices featuring strong functionality, lightweight and simple interface, etc. Generally, the mobile devices include: mobile phones, PDAs and laptops, of which the laptops are an indispensable tool for the individuals and businessmen in their daily life and business activities due to higher availability, popularity and stronger functionality. Additionally, laptop is also a necessary tool for the general public in tune with the widespread Internet-based acts of business and prevailing network. FIG. 1 depicts a conventional laptop 1 with a single display screen 10, whereby the user may find it inconvenient to start several software concurrently. Also, the smaller frame of the single display screen 10 of conventional laptop 1 cannot meet the users' intended acoustic-optic effect when using the multi-media of the laptop 1.

Therefore, a frame splitting software has been developed, allowing to implement independently the operating software within the split frames in a single display screen. However, the users are visually affected and challenged since every split frame becomes smaller.

For this reason, a laptop with double display screens has been developed as disclosed in U.S. Pat. No. 6,343,006, wherein a display screen is connected laterally with the previous display screen of the laptop; such a structure cannot yet satisfy the user demands owing to the fact that two display screens of the laptop are visually used on the same plane; moreover, the shift of the laptop's center of gravity will lead to overturning of the laptop when the other display screen is unfolded. Furthermore, the frame of the laptop will be extended, but the height remains unchanged, leading to the loss of overall proportional and visual effect.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

The primary objective of the present invention is to incorporate additionally two independent display screens onto the common mobile device with a single display screen, thus making it available with three display screens while improving its flexibility in terms of use and operation.

The mobile device of the present invention with multiple display screens is characterized by that, the mobile device at least comprises:

a first display screen, which is assembled at inner side of an upper cover; and one side adjacent to the second display screen is linked to the base;

a second display screen, which is placed on the base; one side is abutted against the first display screen, and the other side abutted against the third display screen; the second display screen can also shift directionally in parallel with the base; and

a third display screen, which is placed at inner side of the keyboard; the other side adjacent to the second display screen is linked to the base.

As a whole, the novelty and inventive steps of the present invention can be demonstrated showing a satisfactory embodiment with intended efficiency; and the technical approaches and efficacies of the present invention will be more readily understood upon a thoughtful deliberation of the following detailed description of a preferred embodiment of the present invention with reference to the accompanying drawings.

### BRIEF DESCRIPTION OF THE DRAWINGS

FIG. 1 shows a schematic view of a typical mobile device.

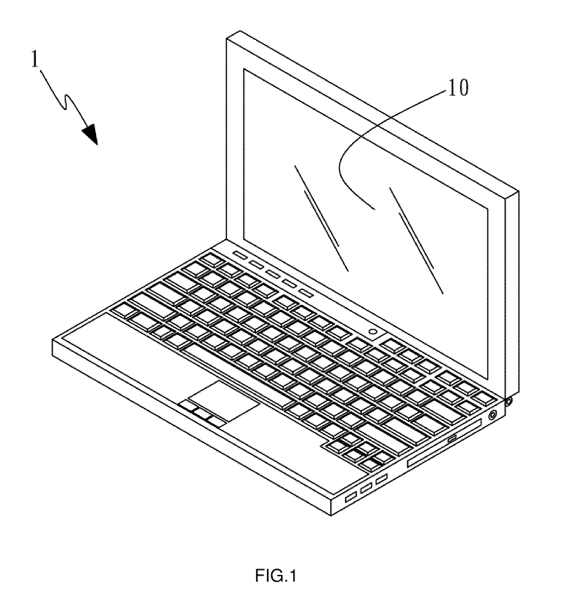

FIG. 2 shows a schematic view of a preferred embodiment of the present invention that the display screens of the mobile device are under an unfolded state.

FIG. 3 shows a schematic view of the present invention that the second display screen of the mobile device is used.

FIG. 4 shows a schematic view of the present invention that the display screens of the mobile device are operated.

FIG. 5 shows a schematic view of another preferred embodiment of the present invention that the display screens of the mobile device are under an unfolded state.

FIG. 6 shows a schematic view of a preferred embodiment of the present invention that the mobile device is under a folding state.

### DETAILED DESCRIPTION OF THE INVENTION

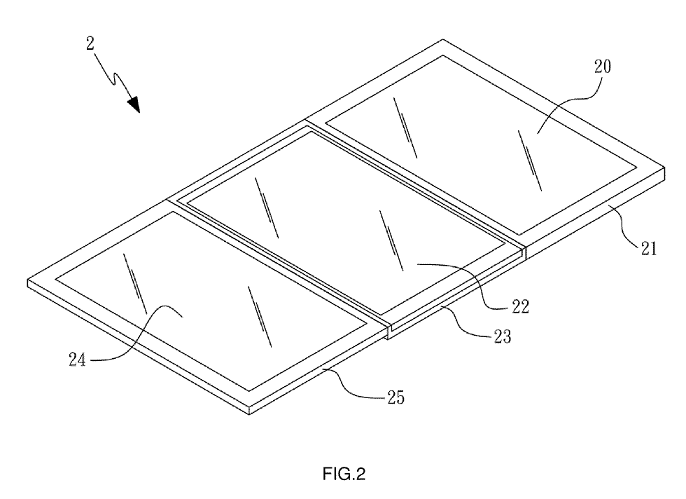

Referring to FIG. 2—a schematic view of a preferred embodiment of the mobile device of the present invention with multiple display screens, wherein the mobile device 2 is structurally based on the laptop, and also under an unfolded state. The mobile device 2 at least includes:

a first display screen 20, which is assembled at inner side of an upper cover 21; and one side adjacent to the second display screen 22 is linked to the base 23;

a second display screen 22, which is placed on the base 23; one side is abutted against the first display screen 20, and the other side abutted against the third display screen 24; the second display screen 22 can also shift directionally in parallel with the base 23; and

a third display screen 24, which is placed at inner side of the keyboard 25; the other side adjacent to the second display screen 22 is linked to the base 23;

of which the first display screen 20 is arranged correspondingly to the third display screen 24;

the first display screen 20 can be rotatably covered in tune with the second display screen 22, whilst the third display screen 24 can also be rotatably covered in tune with the second display screen 22.

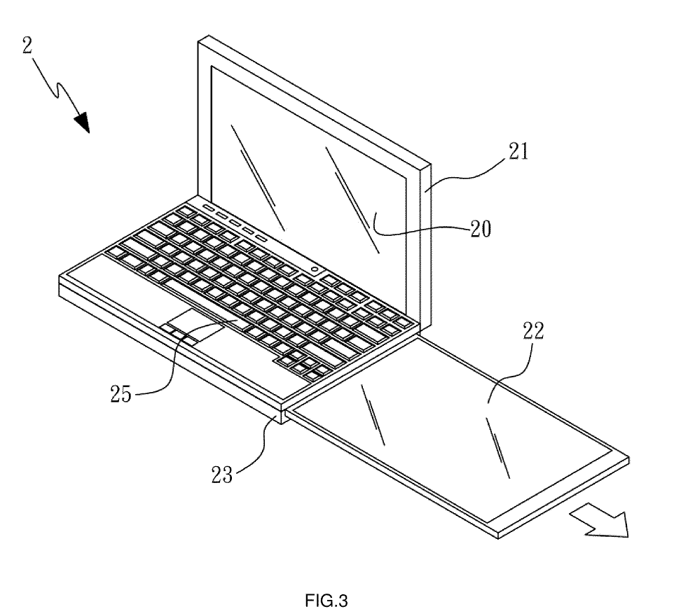

Referring to FIG. 3—a schematic view of the present invention that the mobile device with multiple display screens is used, wherein the mobile device 2 along with the laptop allows to open the upper cover 21, such that the first display screen 20 and the keyboard 25 have an included angle bigger than or equal to 900, making it available for the laptop with single display screen; when it is intended to implement several application software on the mobile device 2, the second display screen 22 can be pulled out of the base 23 and located at right or left side of the keyboard 25. Next, the user can set the application software from the first display screen 20 to the second display screen 22.

For instance, when the mobile device 2 along with the laptop is to implement Microsoft Word and Microsoft PowerPoint simultaneously on the same display screen, the windows for these two software shall be reduced and also arranged transversely or vertically. Generally, the user prefers to switch the software by Tab on the mobile device 2, despite of the troublesome and inconvenient operation. In such case, the second display screen 22 can be pulled out of the base 23 and located at right or left side of the keyboard 25; then Microsoft Word is shifted to the second display screen 22, and Microsoft PowerPoint is set on the first display screen 20, enabling the users to visualize clearly the files or contents opened by Microsoft Word, and edit the files using Microsoft PowerPoint.

The second display screen 22 can also be used as a touch screen. When the user only intends to implement a single application software, this software can be implemented on the first display screen 20, and cursor control or functional selection can be conducted on the second display screen 22.

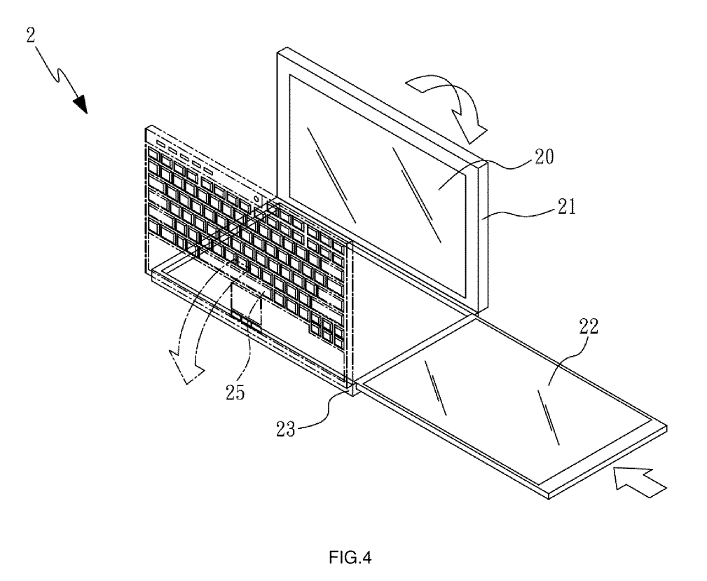

Referring to FIG. 4, when the user intends to use the multi-media via the help of the mobile device 2 of the present invention along with the laptop, e.g. playing of films, the second display screen 22 can be pulled back to be overlapped with the base 23, and the upper cover 21 is turned oppositely to the base 23 and flushed with the second display screen 22; similarly, the keyboard 25 is turned oppositely to the base 23 and flushed with the second display screen 22; referring to FIG. 2, the first, second and third display screens 20, 22, 24 are placed on the same plane, forming a bigger display screen integrating three ones; then, the frame on the first display screen 20 can be zoomed in to promote the users' visual and acoustic-optic effect, and also improve greatly the functionality and operational flexibility of the mobile device 2 along with the laptop.

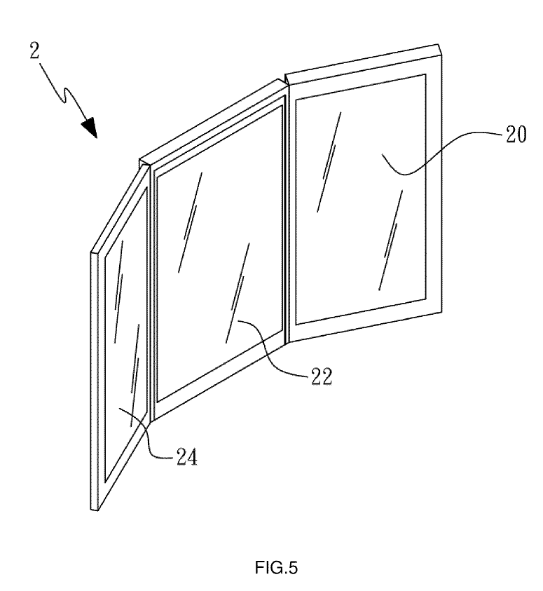

Referring to FIG. 5, the users can also set the first display screen 20, the third display screen 24 and the second display screen 22 into a wide-angle 3D space for image application or playing.

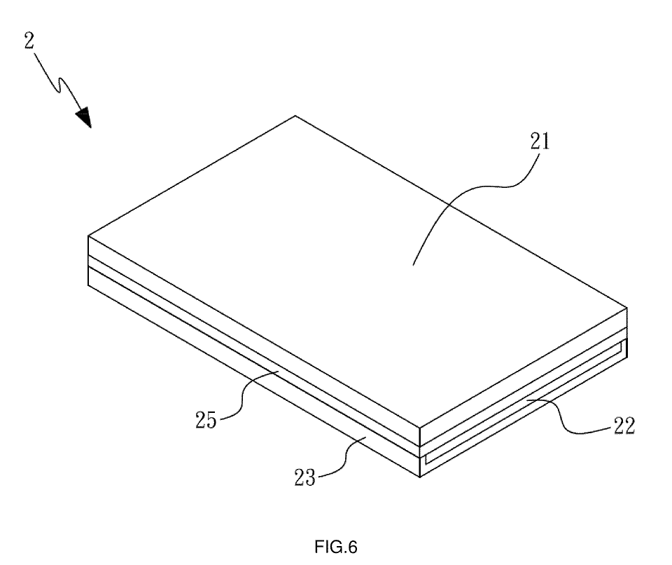

Referring to FIG. 6—a schematic view of the mobile device of the present invention with multiple display screens, when the mobile device 2 along with the laptop is carried, the upper cover 21 is covered onto the keyboard 25, and the keyboard 25 is located on the base 23, while the second display screen 22 is contained into the base 23.

The aforementioned first, second and third display screens 20, 22 and 24 can also be set into touch screen, thus improving the diversified applications and operation.

On the whole, the mobile device of the present invention with multiple display screens can realize the above-specified efficacies, and isn't made publicly available prior to the application, so it meets the novelty and innovative steps of the utility patent.

Although the invention has been explained in relation to its preferred embodiment, it is to be understood that many other possible modifications and variations can be made without departing from the spirit and scope of the invention as hereinafter claimed.

I claim:

1. A mobile device with multiple display screens, which comprising at least:
a first display screen, which is assembled at inner side of an upper cover; and one side adjacent to the second display screen is linked to the base;
a second display screen, which is placed on the base; one side is abutted against the first display screen, and the other side abutted against the third display screen; the second display screen can also shift directionally in parallel with the base; and
a third display screen, which is placed at inner side of the keyboard; the other side adjacent to the second display screen is linked to the base.

2. The device defined in claim 1, wherein the first display screen is arranged correspondingly to the third display screen.

3. The device defined in claim 1, wherein the first display screen can be rotatably covered in tune with the second display screen.

4. The device defined in claim 1, wherein the third display screen can be rotatably covered in tune with the second display screen.

5. The device defined in claim 1, wherein the first display screen can be set into a touch screen.

6. The device defined in claim 1, wherein the second display screen can be set into a touch screen.

7. The device defined in claim 1, wherein the third display screen can be set into a touch screen.
